(19) United States
(12) Patent Application Publication
(10) Pub. No.: US 2008/0260505 A1
(43) Pub. Date: Oct. 23, 2008

(54) CARRIER FOR CARRYING A PACKAGED CHIP AND HANDLER EQUIPPED WITH THE CARRIER

(76) Inventors: Kyoung Won Kang, Daedeok-gu (KR); Jeong Yong Moon, Goyang-si (KR); Hee Rak Beom, Seoul (KR); Jae Myeong Song, Seongnam-si (KR); Hyeong Hee Kim, Cheonan-si (KR)

Correspondence Address: KED & ASSOCIATES, LLP, P.O. Box 221200, Chantilly, VA, 20153-1200, US

(21) Appl. No.: 12/102,301

(22) Filed: Apr. 14, 2008

(30) Foreign Application Priority Data
Apr. 18, 2007 (KR) 10-2007-0038049

(51) Int. Cl. B65G 1/00; B65D 1/36; B65B 21/02

(52) U.S. Cl. 414/281; 206/564; 414/404

(57) ABSTRACT

A carrier for carrying a packaged chip includes a housing having a holding space and at least one guiding hole. A guiding block ascends and descends along the guiding hole. A latch moves backwards and forwards as the guiding block ascends and descends to move into and out of the holding space.

### BACKGROUND

1. Field

The present disclosure relates to a carrier for holding a packaged chip, and a handler equipped with test trays having the carrier.

2. Background

A test handler puts packaged chips through electrical tests at the conclusion of a packaging process. The handler transfers the packaged chips from a user tray to a test tray, and then supplies the test tray containing the packaged chips to a tester. The tester includes a test board with a plurality of sockets. The handler makes the packaged chips in the test tray individually contact with sockets of the test board. The tester then performs the electrical tests on the packaged chips. After sorting the packaged chips according to test results, the handler transfers them from the test tray to the corresponding user trays.

The packaged chips are mounted in the carriers of a test tray before the test tray is transferred to different locations in the handler. The carriers of the test tray prevent the packaged chips from dropping from the test tray as the test tray is moved.

The carriers are arranged in rows and columns on a test tray. One packaged chip is placed into each carrier. When a packaged chip is placed into a carrier, a latch of the carrier holds it firmly in place. When the latch releases the packaged chip, it can be removed from the carrier.

FIG. 1 is an exploded, perspective view of a configuration for a conventional carrier. As shown in FIG. 1, the carrier 1 includes a housing 10. The latch, provided to the housing 10 of the carrier 1, includes a button part 12 and a pressing part 14. The pressing part 14 presses against the packaged chip placed into the carrier 1 to hold it firmly in place. A pushing pin 20 pushes the button part 12 of the latch to release the packaged chip. Thus, the packaged chip can be picked up from the carrier 1. A pin 17, as shown in FIG. 1, connects the latch to the housing 10. The latch holds the packaged chip firmly in place by virtue of spring pressure of a coil spring 18 provided between the pin 17 and the button part 12.

The carrier 1 is subject to outside impact or shock in most environments. When the coil spring 18 is not sufficiently strong to resist such shocks, the latch fails to hold the packaged chips firmly in place. Thus, the packaged chip is prone to drop from the carrier 1.

### BRIEF DESCRIPTION OF THE DRAWINGS

The embodiments will be described in detail with reference to the following drawings, in which like reference numerals refer to like elements, and wherein:

FIG. 1 is an exploded, perspective view of a configuration for a conventional carrier;

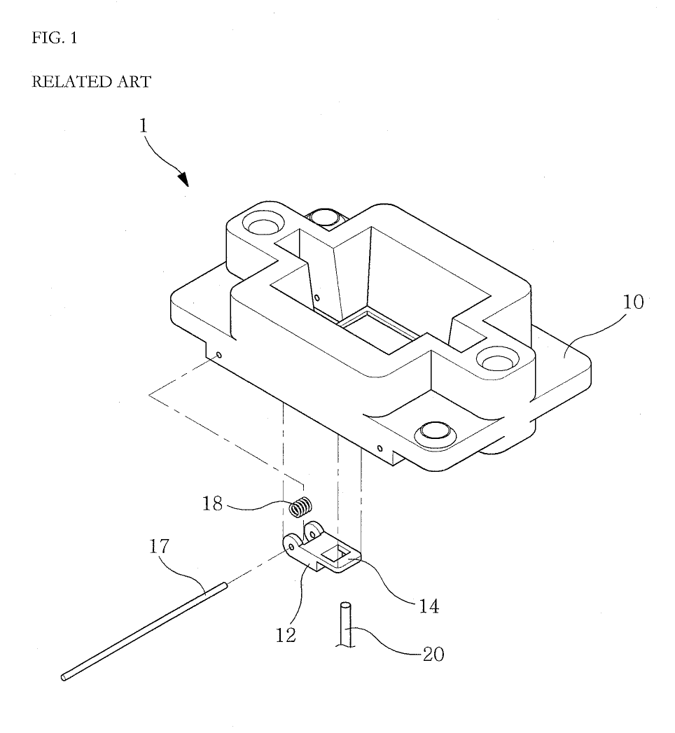

FIG. 2 is an exploded, perspective view of a first embodiment of a carrier for carrying a packaged chip;

FIG. 3 is a cross-sectional view of the carrier shown in FIG. 2, illustrating the latch located at the lower end of a guiding hole;

FIG. 4 is a cross-sectional view of the carrier as shown in FIG. 2, illustrating the latch located at the upper end of the guiding hole;

FIG. 5 is a plan view of a handler equipped with the carrier described in FIGS. 2-4; and

FIG. 6 is an exploded, perspective view of a test tray having the carrier illustrated in FIGS. 2-4, a pushing plate, and a set of vacuum nozzles located over the test tray.

### DETAILED DESCRIPTION

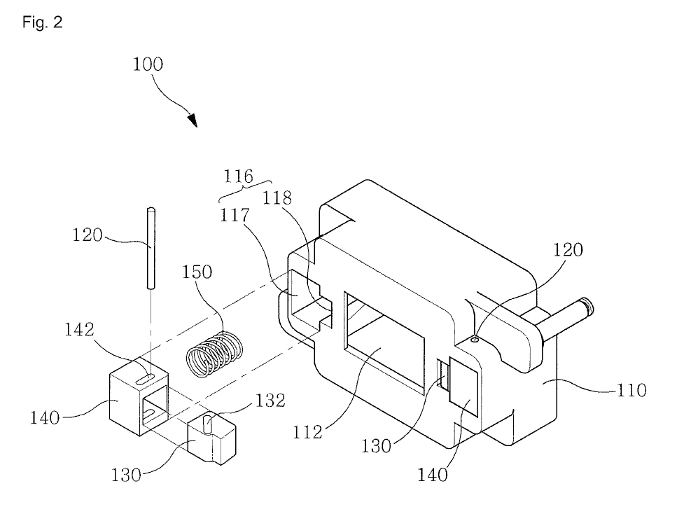

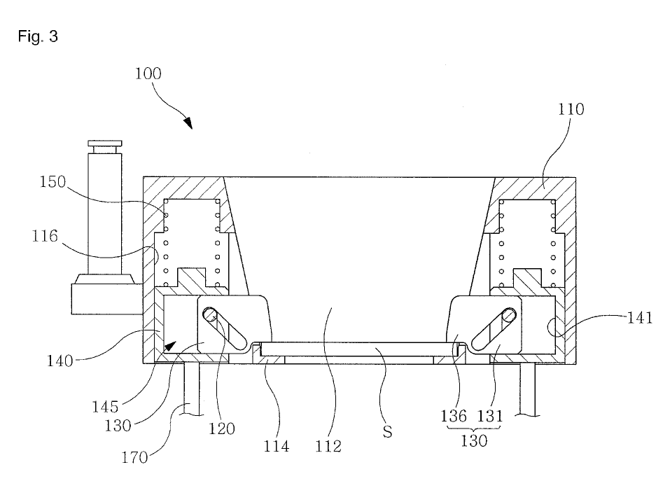

As shown in FIGS. 2 and 3, a carrier 100 for carrying a packaged chip includes a housing 110 having a holding space 112 in the middle thereof. One or more guiding holes 116 are formed at opposite sides of the holding space 112. A guiding block 140 moves along the guiding hole 116, and a latch 130 is inserted into the guiding block 140. The latch 130 is retracted into and extends from the guiding block 140 as the guiding block 140 ascends and descends within the guiding hole 116. An elastic member 150 is inserted into the guiding hole 116 and it presses the guiding block 140 downward.

The holding space 112 is a hole vertically pierced through the housing 110. The holding space 112 is where the packaged chip is placed. The housing 110 also includes a supporting part 114 protruding from the inside lateral surface thereof toward the holding space 112. The supporting part 114 serves to support the packaged chip placed into the holding space 112.

The upper end of the guiding hole 116 is closed, and the lower end is opened. The guiding hole 116 includes a first portion 117, along which the guiding block 140 ascends and descends, and a second portion 118, along which the latch 130 moves backwards and forwards as the guiding block 140 ascends and descends.

The guiding block 140 has an opening in the side. The latch 130 is inserted into the opening in the guiding block 140. The latch 130 moves backwards and forwards inside of the guiding block 140 as the guiding block 140 ascends and descends in the guiding hole 116.

The guiding block 140 has an elongated longitudinal hole 142, piercing opposing sides thereof, with its length being parallel to the direction in which a pushing pin 170 ascends and descends, and also parallel to the direction the guiding block travels within the guiding hole. The latch 130 also has an elongated hole 132, piercing opposite sides thereof, with its length being oriented at an angle with respect to the length of the elongated longitudinal hole 142 on the guiding block. A guiding pin 120 is inserted into the first and second longitudinal holes 142 and 132, and one or both ends of the guiding pin are attached to the housing.

When the guiding block 140 reaches the lower end of the guiding hole 116, the upper end of the elongated hole 132 on the latch is positioned at the same height as the upper end of the elongated longitudinal hole 142 on the guiding block. When the guiding block 140 reaches the upper end of the guiding hole 116, the lower end of the elongated longitudinal hole 132 of the latch is positioned at the same height as the lower end of the elongated longitudinal hole 142 on the guiding block. At this point, the upper end of the elongated hole 132 of the latch may be positioned further from the holding space 112 than the lower end of the elongated hole 132 of the latch. This occurs because the elongated hole 132 of the latch is oriented at an angle to the elongated longitudinal hole 142 of the guiding block.

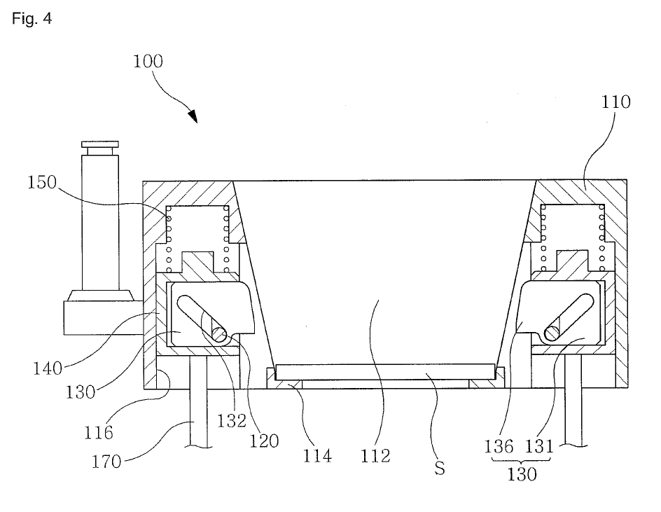

As shown in FIG. 3, when the guiding block 140 reaches the lower end of the guiding hole 116, the guiding pin 120 is positioned at the upper ends of the elongated holes 142 and 132. As shown in FIG. 4, when the guiding block 140 reaches the upper end of the guiding hole 116, the guiding pin 120 is positioned at the lower ends of the elongated holes 142 and 132.

A pushing pin 170 which is a part of a test handler pushes the guiding block 140 upwards to cause the latch to release a chip. When the guiding block 140 ascends from the lower end of the guiding hole 116 to the upper end of the guiding hole 116, the guiding pin moves along the elongated holes. Because the elongated hole of the latch is angled, this upward movement causes the latch 130 to withdraw from the holding space 112 and into the guiding block 140.

The elastic member 150 presses the guiding block 140 downwards. Because the elastic member 150 pushes the guiding block 140 downwards, unless the carrier is given a shock or impact, the guiding block remains positioned at the lower end of the guiding hole 116, which causes the latch 130 to hold the packaged chip firmly in place.

A space between the latch 130 and the guiding block 140 may be small enough to make the latch 130 supportable by the internal sides of the guiding block 140. This ensures that the latch 130 only begins to move upon movement of the guiding block. As a result, the latch 130, although given shock or impact, is not permitted to move unless the guiding block 140 moves.

The latch 130 is not permitted to protrude from the guiding block 140 into the holding space 112, when the latch reaches the upper end of the guiding hole 116. This is done to allow a transferring unit, such as a picker, to pick up the packaged chip from the holding space 112 or to place a chip into the holding space 112.

Referring to FIGS. 3 and 4, operation of a carrier 100 with the above-described configuration is now described. As shown in FIG. 4, a pushing pin 170 ascends to push the guiding block 140 upwards before the transferring unit places a packaged chip into the holding space 112. As the guiding block 140 ascends, the guiding pin 120 moves along the elongated holes 142 and 132. This causes the latch 130 to slide into the guiding block 140 as the guiding block 140 and latch 130 ascend. Thus, the latch 130 is withdrawn from the holding space 112, as shown in FIG. 4.

After this is done, the transferring unit, such as the picker, places a packaged chip into the holding space 112 or removes it from the holding space 112.

The pushing pin 170 then descends and at the same time the elastic member 150, inserted into the guiding hole 116, presses the guiding block 140 downwards. Thus the guiding block 140 descends. As the guiding block 140 descends, the latch 130 descends, and the latch 130 extends out of the guiding block 140 so that it protrudes into the holding space 112 to hold the packaged chip firmly in place.

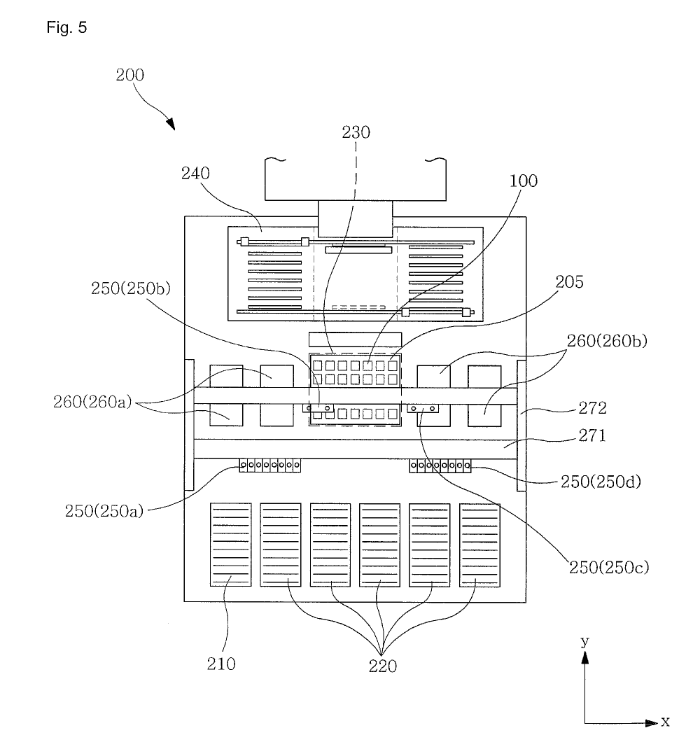

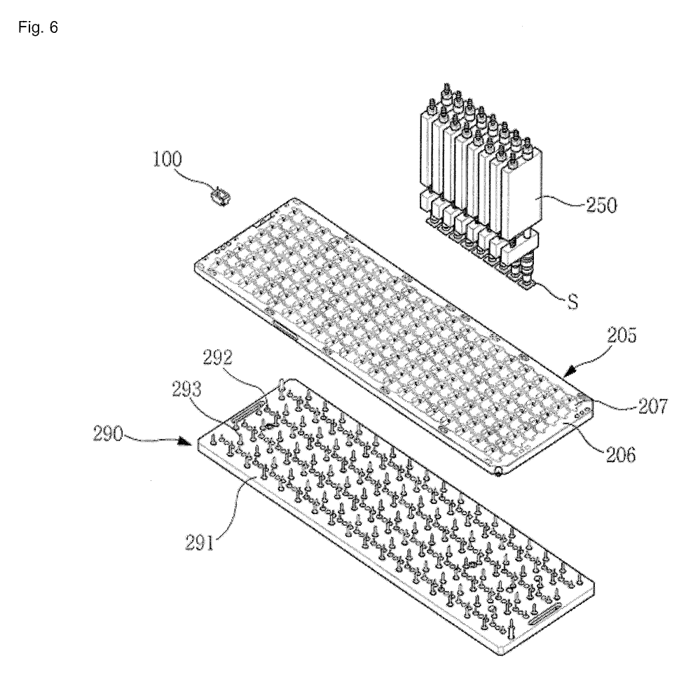

FIG. 5 is a plan view of a test handler equipped with test trays having the carrier described above. FIG. 6 is an exploded, perspective view of a test tray with the carriers, a pushing plate, and suction nozzles.

As shown in FIG. 5, the test handler includes an exchanging site 230, a picker assembly 250, and a pushing plate 290 (refer to FIG. 6). The exchanging site 230 is where the packaged chips are loaded into the test tray and where the tested packaged chips are unloaded from the test tray to be transferred to user trays. The tested packaged chips are graded according to test results and the graded tested packaged chips are loaded into their corresponding user trays, which remain in a stacker.

The test tray 205 includes a plurality of the carriers 100 described above. The packaged chips are placed into the carriers 100. The handler includes at least one picker (250a, 250b, 250c, or 250d) to load the packaged chips S into or unload them from the test tray. The loading picker picks up the packaged chips S to place them into the carriers of the test tray 205, and the unloading picker picks up the tested packaged chips S from the carriers 100 of the test tray 205 to place them into the second user tray 220.

As shown in FIG. 5, the loading picker may include a first picker 250a picking up the packaged chips S from the first user tray 210 to place them on a first buffer unit 260a and a second picker 250b picking up the packaged chips S from the buffer unit 260a to place them into the carriers of the test tray. As shown in FIG. 5, the unloading picker may include a third picker 250c picking up the tested packaged chips S from the test tray to place them on a second buffer unit 260b and a fourth picker 250d picking up the tested packaged chips S from the second buffer to place them into the second user tray 220. The pickers are accordingly provided on X-axis and Y-axis gantries 271 and 272, and are movable along the X-axis gantry 271 and the Y-axis gantry 272. The four pickers are an example, but other embodiments may have a different number of pickers.

The handler may further include a test system 240. The test system 240 includes several chambers, provided behind the handler, where the packaged chips contained in the test tray are heated or cooled to extremely high or low temperature, tested, and cooled or heated to room temperature. The test chamber is where the packaged chips come in contact with sockets of a test board in an outside tester to receive electrical tests.

As shown in FIG. 6, the test tray 205 may include a frame 206 and sockets 207. The carriers 100 are provided on the sockets 207. A pushing plate 290 is positioned under the test tray 205. The pushing plate 290 pushes the latches of the carriers provided on the test tray 205. As shown in FIG. 6, the pushing plate 290 includes a base plate 291 and a plurality of pushing pins 292. The pushing plate 292 is movable upwards and downwards by a driving unit (not shown). The pushing pins 292 are provided on an upper side of the base plate 291 to operate the latches of the carriers 100 provided on the test tray 205.

The base plate 291 may further include two or more guiding pins 293. The guiding pins 293 are provided on an upper side of the base plate 291, adjacent to the pushing pins 292. The guiding pins 293 are longer than the pushing pins 292, and they are inserted into a guiding hole ahead of the pushing pins 292. Thus, the guiding pins 293 guide the pushing pins 292.

A carrier as described above provides an advantage of holding the packaged chips firmly in place regardless of applied forces. Thus the packaged chips are prevented from dropping from the carrier while the test tray containing them moves in the handler.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although a number of illustrative embodiments have been described, it should be understood that numerous other modifications and embodiments can be devised by those skilled in the art that will fall within the spirit and scope of the principles of this disclosure. More particularly, variations and modifications are possible in the component parts and/or the subject combinations which would fall within the scope of the disclosure, the drawings and the appended claims. In addition to variations and modifications in the component parts and/or arrangements, alternative uses will also be apparent to those skilled in the art.

What is claimed is:

1. A carrier for carrying a packaged chip, comprising:
a housing having a holding space for receiving a packaged chip and a guiding hole formed beside the holding space;
a guiding block that is movably mounted in the guiding hole such that it can ascend and descend along the guiding hole; and
a latch that is movably mounted to the guiding block such that as the guiding block ascends in the guiding hole, the latch also ascends and retracts from the holding space.

2. The carrier of claim 1, wherein when the guiding block is located at a lower end of the guiding hole, the latch assumes a closed position where the latch is extended into the holding space to hold a chip in the holding space.

3. The carrier of claim 2, wherein when the guiding block is located at an upper end of the guiding hole, the latch assumes an opened position where the latch is retracted from the holding space to allow a chip to be placed in or removed from the holding space.

4. The carrier of claim 1, wherein the guiding block has a latch receiving aperture, and wherein the latch is mounted in the latch receiving aperture.

5. The carrier of claim 4, wherein the latch retracts into and extends from the latch receiving aperture as the guiding block ascends and descends, respectively, in the guiding hole.

6. The carrier of claim 4, wherein the guiding block has an elongated guide hole on each of two opposite side surfaces thereof, the elongated guide holes extending in a direction that is parallel to a direction which the guiding block moves in the guiding hole, and further comprising a guiding pin that extends through the elongated guide holes, wherein ends of the guiding pin are mounted on the housing.

7. The carrier of claim 6, wherein the latch has an elongated latch hole on each of two opposite side surfaces thereof, the elongated latch holes extending in a direction that is oriented at an angle with respect to the elongated guide holes, wherein the guiding pin also extends through the elongated latch holes.

8. The carrier of claim 7, wherein the orientation of the elongated latch holes causes the latch to retract into and extend from the guiding block as the guiding block and latch ascend and descend in the guiding hole.

9. The carrier of claim 8, further comprising an elastic member mounted in the guiding hole, wherein the elastic member biases the guiding block towards a lower end of the guiding hole.

10. The carrier of claim 4, wherein the latch is supported by inside surfaces of the latch receiving aperture in the guiding block to prevent the latch from rotating as the guiding block and latch ascend and descend in the guiding hole.

11. The carrier of claim 1, further comprising an elastic member mounted in the guiding hole, wherein the elastic member biases the guiding block towards a lower end of the guiding hole.

12. The carrier of claim 1, wherein two guiding holes are formed on opposite sides of the holding space, and wherein a guiding block and latch are mounted in each guiding hole.

13. A test tray comprising the carrier of claim 1.

14. The test tray of claim 13, wherein a plurality of carriers are mounted on the test tray.

15. A test handler comprising the test tray of claim 14.

16. The test handler of claim 15, wherein the test handler includes a pushing unit comprising:
a pushing plate that is movably mounted on the test handler, wherein a plurality of pushing pins are mounted on an upper surface of the pushing plate; and
a driving unit that moves the pushing plate upwards and downwards, wherein when a test tray is located over the pushing plate and the pushing plate is moved upwards, the plurality of pushing pins push on corresponding ones of the guiding blocks of the carriers of the test tray to cause the guiding blocks to ascend within their respective guiding holes.

17. A carrier for carrying a packaged chip, comprising:
a housing having a holding space for receiving a packaged chip and a guiding hole formed beside the holding space;
a guiding block that is movably mounted in the guiding hole such that it can ascend and descend along the guiding hole, the guiding block having elongated guide holes;
a guiding pin mounted on the housing, wherein the guiding pin extends through the guide holes of the guiding block such that as the guiding block ascends and descends within the guiding hole, the guiding pin moves along the elongated guide holes, and
a latch that is movably mounted on the guiding block, wherein the latch has elongated latch holes that are oriented at an angle with respect to the elongated guide holes, and wherein the guiding pin also extends through the elongated latch holes.

18. The carrier of claim 17, wherein the elongated latch holes are oriented such that as the guiding block and latch ascend and descend within the guiding hole, the latch retracts from and extends into the holding space.

19. The carrier of claim 18, wherein when the guiding block is located at a lower end of the guiding hole, the latch assumes a closed position where the latch is extended into the holding space to hold a chip in the holding space, and wherein when the guiding block is located at an upper end of the guiding hole, the latch assumes an opened position where the latch is retracted from the holding space to allow a chip to be placed in or removed from the holding space.

20. The carrier of claim 17, wherein the latch is mounted in an aperture in the guiding block, and wherein the latch retracts into and extends from the guiding block as the guiding block ascends and descends within the guiding hole.
